(19) United States
(12) Patent Application Publication
(10) Pub. No.: US 2011/0018406 A1
(43) Pub. Date: Jan. 27, 2011

(54) FOOD-LINE SERVING COUNTER WITH ADJUSTABLE TRAYSLIDE

(75) Inventors: Alvis Lloyd Hartsfield, JR., Sugar Land, TX (US); Charles Horace Camp, JR., Spring, TX (US)

Correspondence Address: LOCKE LORD BISSELL & LIDDELL LLP, 600 TRAVIS SUITE 2800, HOUSTON, TX, 77002-3095, US

(73) Assignee: KITCHEN EQUIPMENT FABRICATING COMPANY, Houston, TX (US)

(21) Appl. No.: 12/829,737

(22) Filed: Jul. 2, 2010

Related U.S. Application Data
(60) Provisional application No. 61/228,025, filed on Jul. 23, 2009.

(51) Int. Cl. A47B 57/06; A47F 9/00; F16H 19/02

(52) U.S. Cl. 312/140.4; 74/89

(57) ABSTRACT

The disclosure provides a food-line serving counter with an adjustable trayslide that readily adjusts to different heights using the frame of the counter's trayslide elevator assemblies. Multiple trayslide elevator assemblies can be coupled together, even around angles, to allow a variety of types of trayslides, including long and curving trayslides, to be elevated to different heights on the counter. With the present invention, a customer can purchase a food-line serving counter, and use it at a variety of heights for different groups of children, disabled persons, and those with special needs from a single facility and satisfy federal and state requirements. A trayslide actuator can be placed at a variety of locations suitable for the installation and raise the entire trayslide from a single position. Further, the trayslide elevator assembly can include a slider and a slider guide to provide stability and rigidity on the trayslide.

### CROSS REFERENCE TO RELATED APPLICATIONS

This application claims the benefit of U.S. Provisional Application No. 61/228,025, filed Jul. 23, 2009 and entitled, “Food-Line Serving Counter With Adjustable Trayslide”.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

This disclosure relates to a system and method for efficiently adjusting a serving height of food service equipment. More specifically, the disclosure relates to a system and method for efficiently adjusting a serving height of food line serving counters.

2. Description of the Related Art

Food-line serving equipment is well known to all ages. From before grade school, children encounter cafeteria food serving lines with family members eating out for lunch or dinner. The children are too short to see the entrées, and father and mothers often lift the children to a height above the display case to help choose the food as they walk down the serving line with a tray on the trayslide of the food-line. When the children enter elementary school, their relatively short statute has typically grown, but still often needs help seeing the food selections and moving the tray along the trayslide with their hands barely able to reach and manage the tray. As the children grow through their junior high and high school grades, and then to college (if chosen) and beyond, the height is no longer an issue—until then their children are asking to be lifted up to see the food selections and help with the tray.

While the childhood memories are often fond and filled with eating with families or having fun in the school lines, the reality is that the federal government and state government require strict criteria for the height of the food-line serving counters and trayslides for public institutions, such as schools. The required height is dependent on the age of the child primarily served. Thus, an acceptable height for a food-line service counter trayslide in a high school would be unacceptable by governmental regulations for use in an elementary school.

Large school districts satisfy these requirements by buying school specific heights suitable for the particular school to which the equipment is intended. However, for a significant number of school districts in rural and sparsely populated areas, the problem is a significant issue and has been for some time. Often, such school districts have limited resources and limited school buildings. Often, a single facility will be used for different groups of children of different ages and different heights. The difference can span ages from beginning of elementary years through junior high and sometimes through high school. Even if different lunch times are scheduled for different age groups of children, the equipment historically remains at the same height. Thus, the problem has been how to satisfy the government requirements with the range of required heights.

Therefore, there remains a need for a system and method that can change the food-line serving counter trayslide height on the same food-line serving counter, and do it quickly, efficiently, and affordably.

### SUMMARY OF THE INVENTION

The disclosure provides a food-line serving counter with an adjustable trayslide that readily adjusts to different heights using the frame of the counter's trayslide elevator assemblies. Multiple trayslide elevator assemblies can be coupled together, even around angles, to allow a variety of types of trayslides, including long and curving trayslides, to be elevated to different heights on the counter. With the present invention, a customer can purchase a food-line serving counter, and use it at a variety of heights for different groups of children, disabled persons, and those with special needs from a single facility and satisfy federal and state requirements. A trayslide actuator can be placed at a variety of locations suitable for the installation and raise the entire trayslide from a single position. Further, the trayslide elevator assembly can include a slider and a slider guide to provide stability and rigidity for the trayslide.

The disclosure provides a food-line serving counter, comprising: a frame of structural members coupled together that forms a food-line serving counter frame; a counter top panel coupled to the frame; a trayslide slidably coupled to the frame; a first trayslide elevator assembly comprising: a linear actuator having a first input shaft, a second input shaft, and an output rod; and a slider coupled to the trayslide, wherein the output rod is coupled to the slider; and a second trayslide elevator assembly comprising: a linear actuator having at least a first input shaft and an output rod; and a slider coupled to the trayslide, wherein the output rod is coupled to the slider; wherein the second input shaft of the linear actuator of the first trayslide elevator assembly is coupled to the first input shaft of the linear actuator of the second trayslide so that each of the trayslide elevator assemblies move in uniformity with each other; a trayslide adjustor coupled to the first input shaft of the linear actuator of the first trayslide elevator assembly and adapted to cause the trayslide elevator assemblies to move the trayslide to a plurality of heights relative to the frame.

The disclosure also provides a food-line serving counter, comprising: a frame of structural members coupled together that forms a food-line serving counter frame; a counter top panel coupled to the frame; a plurality of trayslide elevator assemblies coupled to the frame; a trayslide coupled to the trayslide elevator assemblies and slidably coupled to the frame; and a trayslide adjustor coupled to the trayslide elevator assemblies and adapted to cause the trayslide elevator assemblies to move the trayslide to a plurality of heights relative to the frame.

### BRIEF DESCRIPTION OF THE SEVERAL VIEWS OF THE DRAWINGS

The informal figures contain exemplary steps, diagrams, illustrations, and specifications for a food-line serving counter with adjustable trayslide in keeping with the statutory disclosures required for a patent application.

FIG. 1A is a front perspective schematic of an exemplary food-line serving counter with an adjustable trayslide.

FIG. 1B is a side schematic of the exemplary food-line serving counter of FIG. 1A.

FIG. 1C is a rear schematic of the exemplary food-line serving counter of FIG. 1A.

FIG. 1D is a rear perspective schematic of the exemplary food-line serving counter of FIG. 1A.

FIG. 2 is a front perspective schematic of the exemplary food-line serving counter frame and components for the adjustable trayslide.

FIG. 3 is a rear perspective schematic of the exemplary food-line serving counter frame and components.

FIG. 4 is a top schematic of the exemplary food-line serving counter frame and components.

FIG. 5A is a rear perspective schematic of a trayslide elevator assembly of the exemplary food-line serving counter.

FIG. 5B is a front perspective schematic of the trayslide elevator assembly.

FIG. 5C is a side schematic of the trayslide elevator assembly.

FIG. 6 is a schematic top view of an exemplary curved food-line serving counter with an adjustable trayslide.

FIG. 7 is a schematic top view of an exemplary curved food-line serving counter with a motorized adjustable trayslide.

FIG. 8 is a schematic rear perspective view of the embodiment of FIG. 7.

### DETAILED DESCRIPTION

The Figures described above and the written description of specific structures and functions below are not presented to limit the scope of what Applicants have invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of ordinary skill in this art having benefit of this disclosure. It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims. Where appropriate, elements have been labeled with an “a” or “b” to designate one side of the system or another. When referring generally to such elements, the number without the letter is used. Further, such designations do not limit the number of elements that can be used for that function.

In general, the disclosure provides a food-line serving counter with an adjustable trayslide that readily adjusts to different heights using the frame of the counter's trayslide elevator assemblies. Multiple trayslide elevator assemblies can be coupled together, even around angles, to allow a variety of types of trayslides, including long and curving trayslides, to be elevated to different heights on the counter. With the present invention, a customer can purchase a food-line serving counter, and use it at a variety of heights for different groups of children, disabled persons, and those with special needs from a single facility and satisfy federal and state requirements. A trayslide actuator can be placed at a variety of locations suitable for the installation and raise the entire trayslide from a single position. Further, the trayslide elevator assembly can include a slider and a slider guide to provide stability and rigidity for the trayslide

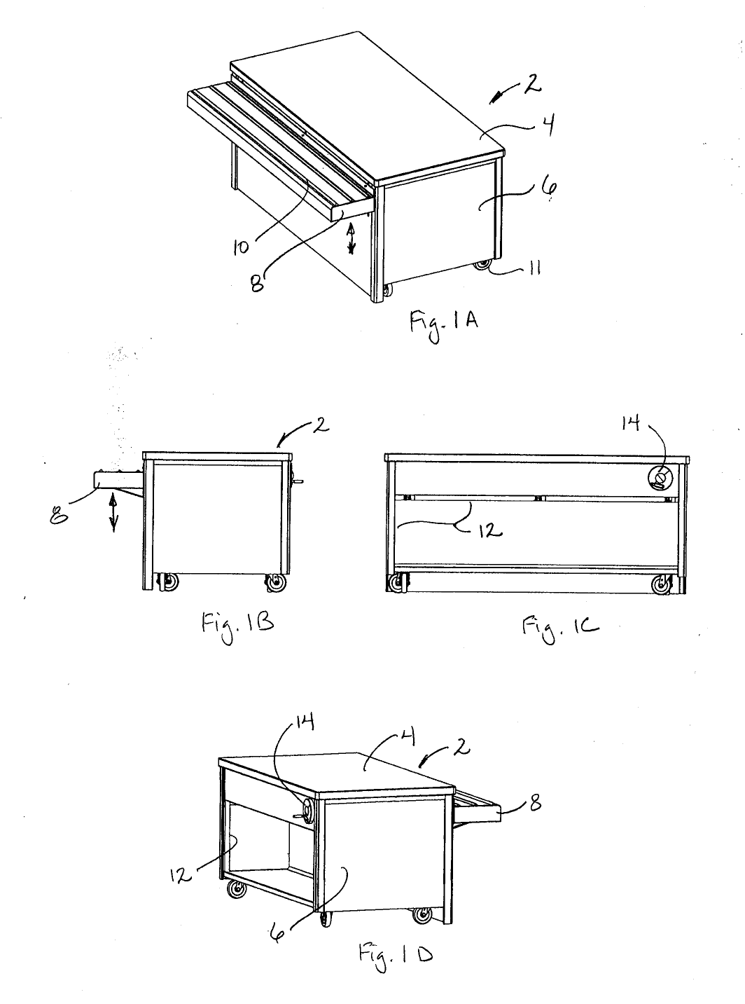

FIG. 1A is a front perspective schematic of an exemplary food-line serving counter with an adjustable trayslide. FIG. 1B is a side schematic of the exemplary food-line serving counter of FIG. 1A. FIG. 1C is a rear schematic diagram of the exemplary food-line serving counter of FIG. 1A. FIG. 1D is a rear perspective schematic of the exemplary food-line serving counter of FIG. 1A. The figures will be described in conjunction with each other. General assemblies of food-line serving counters for serving food, beverages, and other food related products are known in the art, except for the adjustable trayslide and related components and assemblies described herein. Thus, the general construction, height, depth, materials, and other aspects of the food-line serving counter need not be described in detail. However, generally, the food-line serving counter 2 includes a countertop 4 that is disposed on a frame 12, shown in FIG. 1C. The frame 12 can include a variety of structural members that can be, but are not limited to, structural tubing, bars, angles, plates, and other structural components. One or more counter panels 6 can be coupled to the frame 12, for example, on a front and sides of the counter, leaving the rear of the counter open for storage and access. Generally and without limitation, the counter panel can be a relatively thin sheet metal that is coupled to the frame 12. The counter is often constructed of stainless steel or other suitable materials.

The food-line serving counter 2 of the present disclosure includes an adjustable trayslide 8. The trayslide 8 generally includes one or more ridges 10 that lift the surface of the tray (not shown) typically used for food lines above the main upper surface of the trayslide 8. However, some trayslides may not include the ridges. As disclosed herein, the trayslide 8 is adjustable at a variety of heights, which offer significant advantages over other food-line serving counters in the field. The food-line serving counter 2 can include one or more wheels 11 for ease in relocating the counter to a variety of locations.

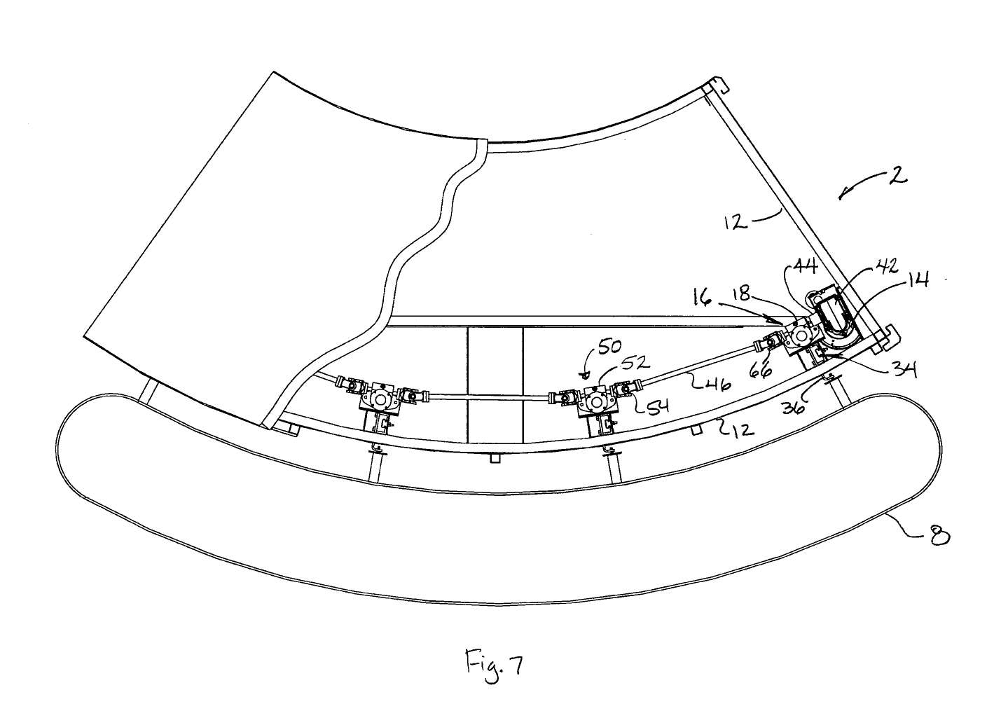

In at least one embodiment, a trayslide adjustor 14 can be disposed at some convenient position, such as toward the rear of the counter 2. The trayslide adjustor 14 is used to change the adjustable trayslide 8 to a variety of heights. In at least one embodiment, the trayslide adjustor 14 can be a crank hand wheel that can be rotated to change the height of the trayslide. In other embodiments, the trayslide adjustor 14 can be a powered unit, such as an electric or hydraulic motor, or other motive devices, such as shown in FIG. 7.

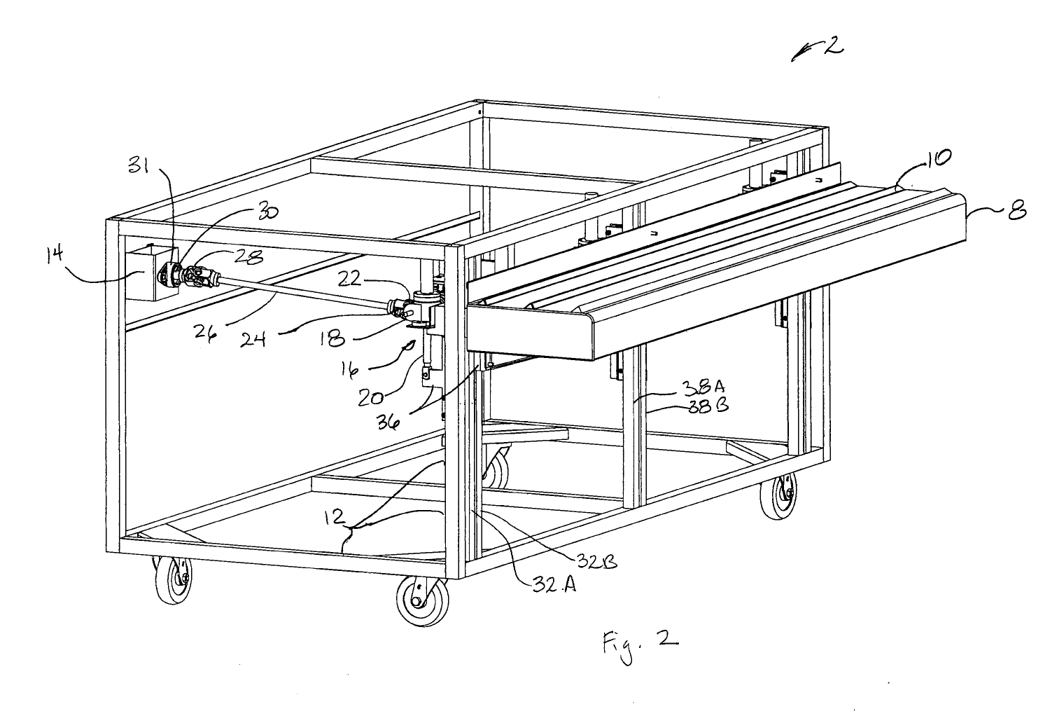

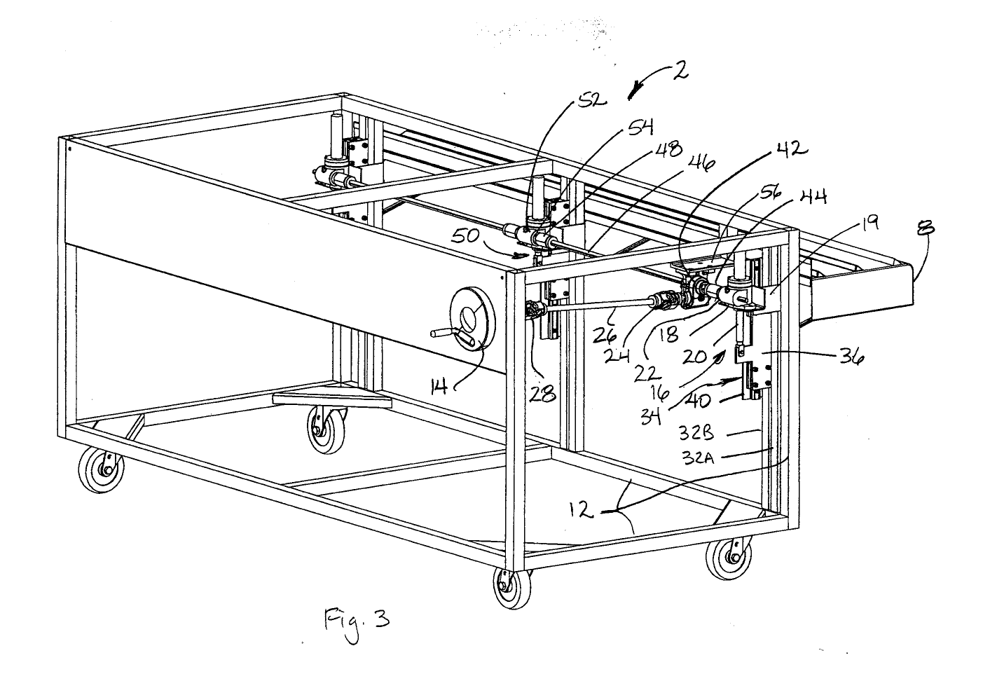

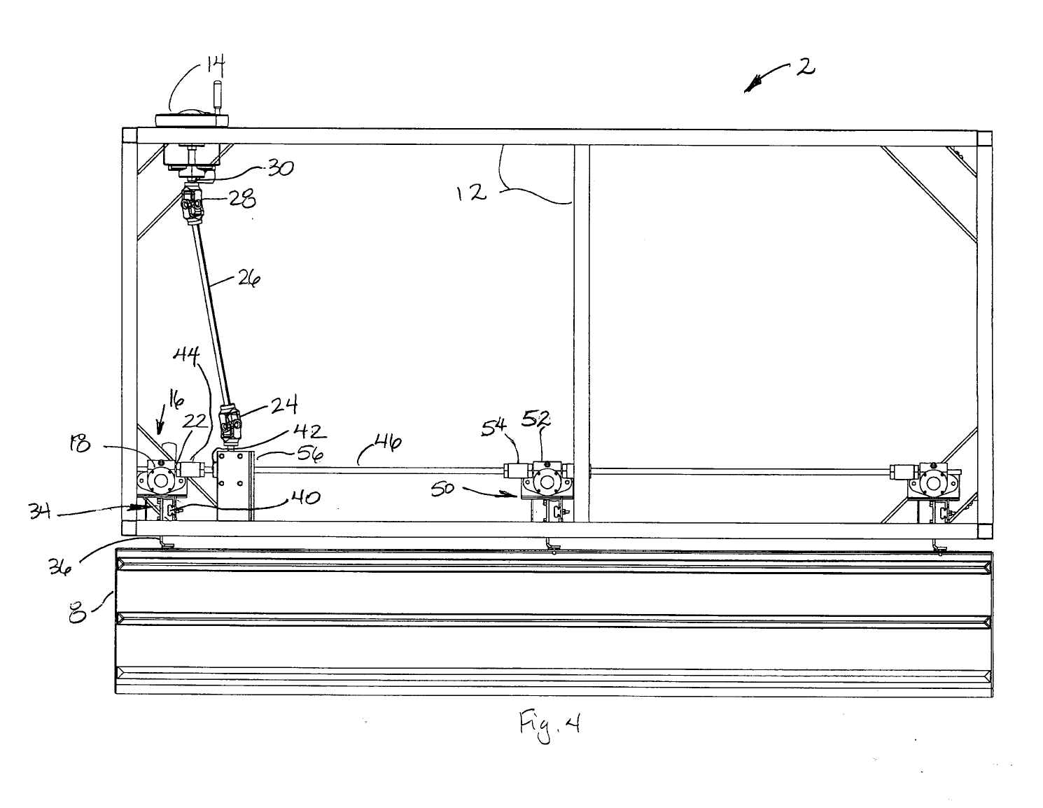

FIG. 2 is a front perspective schematic of the exemplary food-line serving counter frame and components for the adjustable trayslide. FIG. 3 is a rear perspective schematic of the exemplary food-line serving counter frame and components. FIG. 4 is a top schematic of the exemplary food-line serving counter frame and components. The figures will be described in conjunction with each other. The exemplary food-line serving counter 2 and its frame 12 can be used to locate and couple various components described herein that enable the adjustable trayslide 8 to change to a variety of heights relative to the frame. The particular exact locations of the components can vary, depending upon whether the components are pushing or pulling the trayslide to different heights, whether the trayslide adjustor is located in an upper portion or lower portion of the counter, the particular configuration of the counter and ease of accessibility, and other factors that may vary from counter to counter, but are within the scope of the disclosure described herein. Thus, the embodiments of the food-line serving counter with the adjustable tray that are disclosed herein are merely representative of the concepts and ideas that can be used in a variety of configurations, as would be known to those with ordinary skill in the art given the disclosure herein.

In general, the food-line serving counter 2 includes a frame 12 of structural members coupled together that forms a food-line serving counter frame, a counter top panel coupled to the frame, and a trayslide slidably coupled to the frame that can be positioned at various heights. The food-line serving counter further includes one or more trayslide elevator assemblies coupled to the frame. The trayslide is coupled to the trayslide elevator assemblies and slidably coupled to the frame. A trayslide adjustor is coupled to the trayslide elevator assemblies and adapted to cause the trayslide elevator assemblies to move the trayslide to a plurality of heights relative to the frame.

More specifically, the food-line serving counter 2 includes a frame 12 that can be of various configurations, including linear and nonlinear configurations, such that the interface between the trayslide and the frame could be along a linear path, a curved path, an angled path, or other various shapes. Thus, the present invention can accommodate a variety of interfaces, even nonlinear interfaces, by aligning shafts of the trayslide elevator assemblies in a linear and nonlinear manner, described below.

The trayslide adjustor 14, referenced above, can be coupled to the frame 12 directly or through a panel coupled to the frame. The trayslide adjustor 14 can include a central adjustor shaft 30. To maintain position of the adjustor shaft 30, a bearing 31 can be mounted to the frame 12. In at least one embodiment, the bearing 31 can be a flange mount bearing with a hole for the adjustor shaft 30 in which the adjustor shaft 30 can rotate. Further, the trayslide adjustor 14 is coupled to a trayslide elevator assembly 16. The trayslide elevator assembly 16 includes a variety of components that together can be actuated and cause the trayslide 8 to change to a variety of heights. The trayslide elevator assembly 16 generally includes a linear actuator 18. The linear actuator 18 can be a screw jack or other device causing the linear movement based upon input actuation from the trayslide adjustor. For example and without limitation, the linear actuator can be a Nook Mod. No. MJ-20 available from Nook Industries, Inc. of Cleveland, Ohio, USA. The linear actuator 18 can be fixedly coupled to the frame 12 with a bracket 19, so that linear actuator can be fixed relative to the frame, in at least one embodiment. For example, the bracket 19 can be coupled to the riser 32A that is disposed adjacent a second riser 32B, with a space formed therebetween, described in more detail below.

The linear actuator 18 includes an actuator input shaft 22 and an actuator output rod 20. The actuator input shaft 22 can be rotated in reversible directions by the trayslide adjustor 14 to move the actuator output rod 20 upward or downward, depending on whether the trayslide 8 is to be raised or lowered. In at least one embodiment, the linear actuator can include an internal reducer, such that the input shaft 22 can be rotated several revolutions to cause a relatively small change in the linear position of the output rod 20. The actuator output rod 20 of the linear actuator 18 can be coupled to a slider 34 having a bracket 36 that supports the trayslide 8, referenced above. As the actuator output rod 20 moves up and down, it moves up and down the bracket 36 with the trayslide 8 coupled thereto.

In some embodiments, a direct connection between the trayslide adjustor 14 and associated intermediate shafts and couplings can be made to the linear actuator 18. In other embodiments, an intermediate component can be used to transfer the rotation of the trayslide adjustor 14 into an orthogonal direction as illustrated, for example, in FIG. 3. The intermediate piece can be a drive unit 42, such as a gearbox and more particularly can be a right angle gearbox. In some embodiments, the gearbox can include reduction gearing to change the input rotations relative to the output rotations. For example and without limitation, the drive unit 42 can be a right angle gearbox Tolomatic Mod. No. 0111-0000 available from Tolomatic, Inc. of Hamel, Minn., USA. The drive unit 42 can be fixedly coupled to the frame 12 through a bracket 56 or other fastening members. The drive unit 42 can be coupled to the trayslide adjustor 14 through one of more couplings 24, 28, and an extension shaft 26 therebetween. In at least one embodiment, the couplings 24, 28 can be flexible couplings, including U-joints to allow for an angular alignment between the trayslide adjustor and the drive unit 42. In other embodiments, such as shown, for example, in FIG. 7, the trayslide adjustor 14 can be a switch that actuates an electrical or hydraulic motor that can turn the input shaft of the drive unit 42 or even directly turn the input shaft of the linear actuator 18.

In some embodiments, the drive unit 42 and the linear actuator 18 can be mounted in an upper portion on the frame. In such upper portion, the linear actuator 18 will effectively be pulling the trayslide 8 into higher elevations. Further, the trayslide adjustor 14 can be more aligned with the drive unit 42, when the trayslide adjustor is also mounted in an upper portion of the frame. Alternatively, the drive unit, and/or linear actuator can be located on a lower portion of the frame 12, so that the linear actuator 18 will be pushing the trayslide 8 into an upper elevation. If the trayslide adjustor 14 is still located in the upper position on the frame, then the angle between the trayslide adjustor 14 along the extension shaft 26 down to the drive unit 42 will be increased.

Although other arrangements are contemplated, the output portion of the drive unit 42 can be coupled to an extension shaft 46. The extension shaft 46 can be coupled to the input shaft of the linear actuator 18 by an intermediate coupling 44.

At least some embodiments can include a plurality of trayslide elevator assemblies. For example, a second trayslide elevator assembly 50 is shown mounted to the frame 12 and operates in a similar fashion as the trayslide elevator assembly 16. The trayslide assemblies 16, 50 can be rotationally coupled to each other via intermediate couplings 44, 48 and the extension shaft 46. The couplings 44, 48 can be any number of types of couplings and can include rigid and flexible couplings. A flexible coupling allows the input shafts of multiple trayslide elevator assemblies to be oriented at an angle to each other and thereby accommodate nonlinear arrangements of the frame 12 with the trayslide 8 and the interface therebetween. Similar to the coupling 44, the coupling 48 can be coupled to the extension shaft 46 and the input shaft 54 of the second trayslide elevator assembly 50. Thus, the trayslide elevator assemblies 16, 50 move in conjunction with each other. Depending on the length and weight of the trayslide and other factors, additional trayslide elevator assemblies can be coupled to the frame 12 and to the trayslide 8.

Commercially and from an engineering perspective, it is desirable that the trayslide 8 has sufficient rigidity relative to the frame 12. Generally, when the trayslide of a prior serving counter is at a fixed height, the design can include suitable weldments and other rigid connections that provide rigidity to the trayslide. However, because the adjustable trayslide 8 is slidably coupled to the frame, an amount of rigidity can be otherwise compromised without sufficient components and structure. To increase the rigidity, the slider 34 and accompanying components can be used to provide lateral stability to the movement of the trayslide 8. The slider 34 is used to guide the bracket 36 as it is moved up and down. The slider 34 generally includes a slider guide 40 and a corresponding bracket guide 60. The slider guide 40 is fixedly coupled to the frame 12. The bracket guide 60 is fixedly coupled to the bracket 36 that is coupled to the trayslide 8. The slider guide 40 and the bracket guide 60 interface to maintain lateral alignment for the slider and ultimately the trayslide 8.

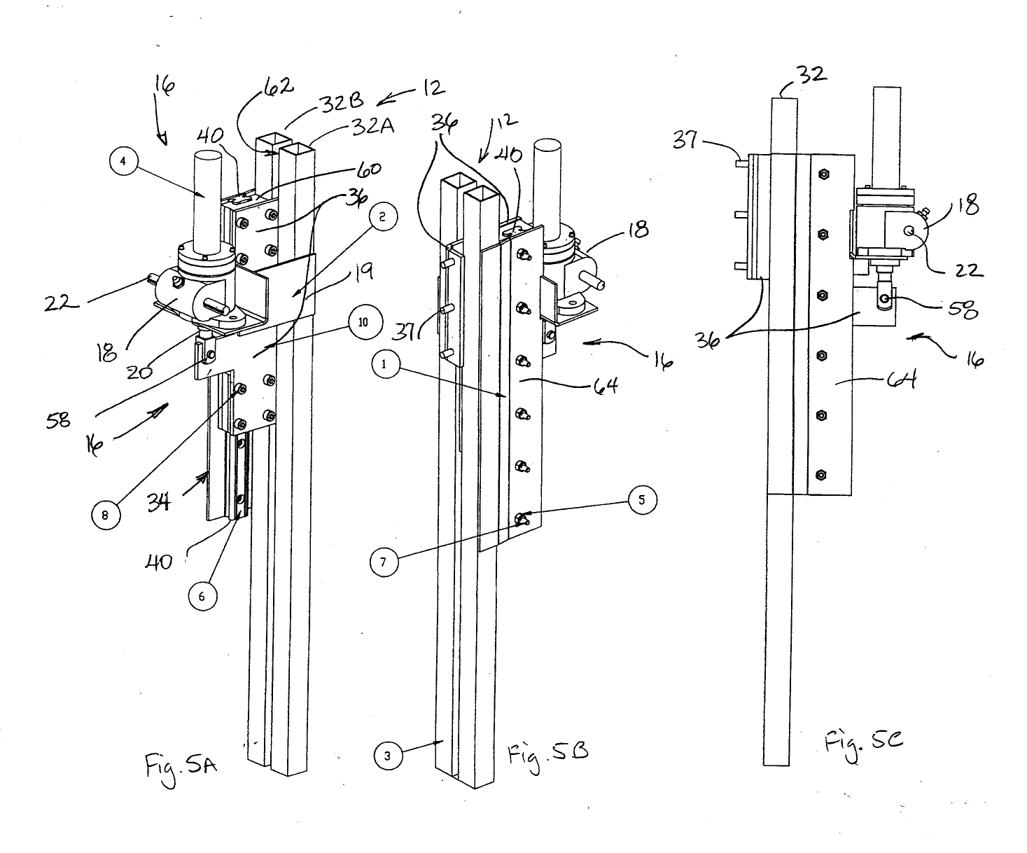

FIG. 5A is a rear perspective schematic of a trayslide elevator assembly of the exemplary food-line serving counter. FIG. 5B is a front perspective schematic of the trayslide elevator assembly. FIG. 5C is a side schematic of the trayslide elevator assembly. The figures will be described in conjunction with each other. As described above, the trayslide elevator assembly 16 includes a variety of components that generally translate a rotational input into a linear output to move the trayslide 8 to various heights. The trayslide elevator assembly 16 includes the linear actuator 18 that can be coupled via the bracket 19 to the riser 32A of the frame 12. In at least one embodiment, the riser 32A is spaced apart from an adjacent riser 32B by a space 62. The linear actuator 18 generally includes the input shaft 22 that can be rotated to change the linear position of the actuator output rod 20. The actuator output rod 20 is coupled via a coupling 58 to the bracket 36 that can extend along a length of the trayslide elevator assembly 16. In at least one embodiment, the bracket 36 can extend outwardly through the space 62 between the risers 32A, 32B to allow attachment of the trayslide 8 to the bracket, as shown in the top view of FIG. 4. One or more fasteners 37 can be used to couple the trayslide 8 to the bracket 36. To guide the bracket 36 laterally as it moves up and down, the slider 34 can include the slider guide 40. The slider guide 40 is generally fixably coupled to one or more of the risers, such as riser 32B via a bracket 62. For example, without limitation, a slider 34 can include a linear guide system, PBC Mod. No. MRE20-320 available from PBC Linear, Pacific Bearing Company of Roscoe, Ill., USA. In the illustration shown in FIGS. 5A-5C, the slider guide 40 can represent the male component of the slider 34, such as the rail. A corresponding bracket guide 60 is used to engage the slider guide 40 and can represent the female component of the slider 34, such as the carrier. The bracket guide 60 is generally coupled to the bracket 36 and can move up and down in conjunction with the movement of the actuator output rod 20. Thus, the slider guide 40 is fixedly coupled to the frame 12, while the bracket guide 60 is slidably coupled to the frame 12 along with the bracket 36. Thus, the standard orthogonal “x”-axis and “y”-axis are restrained and provide stability to the movement of the trayslide in the “z”-axis. Further, the position of the bracket 36 within the space 62 between the risers 32A, 32B can add further stability to the range of movements available to the bracket 36 and thence to the trayslide 8.

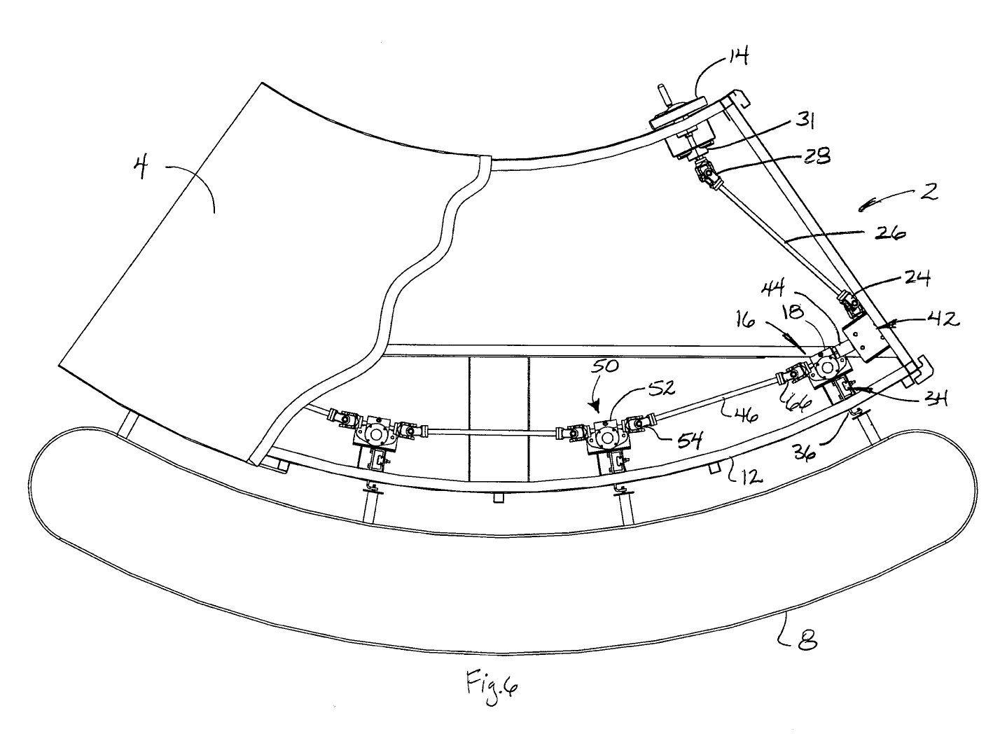

FIG. 6 is a schematic top view of an exemplary nonlinear food-line serving counter with an adjustable trayslide. As described above, the food-line serving counter 2 includes a frame 12 that can be of various configurations, including nonlinear configurations, such that the interface between the trayslide 8 and the frame 12 could be along a curved path, an angled path, or other various shapes. The food-line serving counter 2 with a counter top 4 and an adjustable trayslide 8 is similar to the counters described above. The exemplary elements have been described and generally include the trayslide adjustor 14 coupled to the counter 2 in an appropriate position, such as on a rear of the counter. The trayslide adjustor 14 can be coupled to a drive unit 42 through one or more couplings 24, 28 with an extension shaft 26 therebetween. The output portion of the drive unit 42 can be coupled to an input shaft of the linear actuator 18 of the trayslide elevator assembly 16 through an intermediate coupling 44.

A plurality of trayslide elevator assemblies can be coupled around the nonlinear interface of the frame 12 with the nonlinear adjustable trayslide 8 by extension shafts and flexible couplings, such as U-joints or other couplings that allow angular misalignment. For example, the trayslide elevator assembly 16 can be coupled to the trayslide elevator assembly 50 through flexible couplings 66, 54 with an extension shaft 46, disposed therebetween at an angle to one or both of the trayslide elevator assemblies. The movement of the trayslide assemblies 16, 50 with their linear actuators 18, 52 and respective sliders 34 and brackets 36 is thus synchronized with each other even around a nonlinear interface, so that the adjustable trayslide 8 can uniformly move up and down.

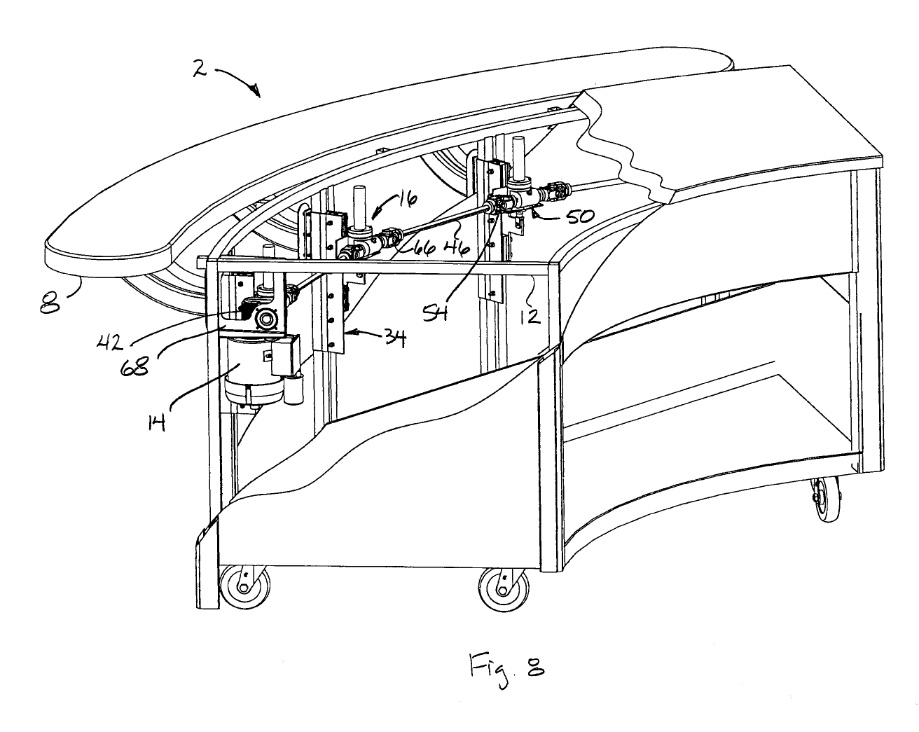

FIG. 7 is a schematic top view of an exemplary curved food-line serving counter with a powered adjustable trayslide. FIG. 8 is a schematic rear perspective view of the embodiment of FIG. 7. The figures will be described in conjunction with each other. The food-line serving counter 2 with a counter top 4 and an adjustable trayslide 8 is similar to the counters described above. The exemplary elements have been described and generally include the frame 12 with various components coupled thereto, such as the trayslide elevator assemblies 16, 50 with their linear actuators 18, 52 and respective sliders 34 and brackets 36 that can change the elevation of the adjustable trayslide 8. The multiple trayslide elevator assemblies can be coupled to synchronize movement therebetween for the adjustable trayslide, for example, through flexible couplings 66, 54 with an extension shaft 46 disposed therebetween.

In one or more embodiments, the trayslide adjustor that causes the adjustable trayslide to move to a variety of elevations can be powered, such as by an electric motor. The trayslide adjustor 14 shown in FIGS. 6 and 7 can include an electric motor and can be coupled to a drive unit 42. In at least one embodiment, the two components are preassembled and supplied together as a “gearmotor.” The size, shape, and construction of the powered trayslide adjuster 14, and the drive unit coupled thereto, if present, can vary depending on the needs of the actual configuration of the food-line serving counter. For example and without limitation, an assembly can include a Bison 756 Series PSC right angle gearmotor Mod. No. 026-756-4410, available from Bison Gear & Engineering Corp. of St. Charles, Ill. In the exemplary embodiment, the electric motor is reversible and can be limited in its operation by limit switches (not shown) to determine travel stops for the slider 34. A switch (not shown) can be pressed or otherwise moved to switch the motor on and off. The actuator 14 can be mounted in proximity to the trayslide elevator assembly 16 such as on a bracket 68 coupled to the frame 12. An output shaft of the powered actuator 14, or of the assembly, if present, of the actuator 14 and drive unit 42, can be coupled to the trayslide elevator assembly 16. The trayslide elevator 16 and the trayslide elevator assembly 50 coupled thereto can cause the powered movement of the adjustable trayslide 8 to be synchronized.

Other and further embodiments utilizing one or more aspects of the inventions described above can be devised without departing from the spirit of Applicant's invention. Further, the various methods and embodiments of the food-line serving counter can be included in combination with each other to produce variations of the disclosed methods and embodiments. Discussion of singular elements can include plural elements and vice-versa. References to at least one item followed by a reference to the item may include one or more items. Also, various aspects of the embodiments could be used in conjunction with each other to accomplish the understood goals of the disclosure. Unless the context requires otherwise, the word “comprise” or variations such as “comprises” or “comprising,” should be understood to imply the inclusion of at least the stated element or step or group of elements or steps or equivalents thereof, and not the exclusion of a greater numerical quantity or any other element or step or group of elements or steps or equivalents thereof. The device or system may be used in a number of directions and orientations. The term “coupled,” “coupling,” “coupler,” and like terms are used broadly herein and may include any method or device for securing, binding, bonding, fastening, attaching, joining, inserting therein, forming thereon or therein, communicating, or otherwise associating, for example, mechanically, magnetically, electrically, chemically, operably, directly or indirectly with intermediate elements, one or more pieces of members together and may further include without limitation integrally forming one functional member with another in a unity fashion. The coupling may occur in any direction, including rotationally.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intend to protect fully all such modifications and improvements that come within the scope or range of equivalent of the following claims.

What is claimed is:

1. A food-line serving counter, comprising:
a frame of structural members coupled together that forms a food-line serving counter frame;
a counter top panel coupled to the frame;
a trayslide slidably coupled to the frame;
a first trayslide elevator assembly comprising:
a linear actuator having a first input shaft and a first output rod; and
a slider coupled to the trayslide, wherein the first output rod is coupled to the slider; and
a second trayslide elevator assembly comprising:
a linear actuator having at least a second input shaft and a second output rod; and
a slider coupled to the trayslide, wherein the second output rod is coupled to the slider;
wherein the first input shaft of the linear actuator of the first trayslide elevator assembly is coupled to the second input shaft of the linear actuator of the second trayslide elevator assembly so that each of the trayslide elevator assemblies move in uniformity with each other;
a trayslide adjustor coupled to the first input shaft of the linear actuator of the first trayslide elevator assembly and adapted to cause the trayslide elevator assemblies to move the trayslide to a plurality of heights relative to the frame.

2. The food-line serving counter of claim 1, wherein at least a portion of the frame and a mating portion of the trayslide are non-linear.

3. The food-line serving counter of claim 1, wherein at least a portion of the frame and a mating portion of the trayslide are non-linear, and the first input shaft of the linear actuator of the first trayslide elevator assembly is coupled non-linearly to the second input shaft of the linear actuator of the second trayslide elevator assembly.

4. A food-line serving counter, comprising:
a frame of structural members coupled together that forms a food-line serving counter frame;
a counter top panel coupled to the frame;
a plurality of trayslide elevator assemblies coupled to the frame;
a trayslide coupled to the trayslide elevator assemblies and slidably coupled to the frame; and
a trayslide adjustor coupled to the trayslide elevator assemblies and adapted to cause the trayslide elevator assemblies to move the trayslide to a plurality of heights relative to the frame.

5. The food-line serving counter of claim 4, wherein at least one of the trayslide elevator assemblies comprises:
a linear actuator having an input shaft and an output rod; and
a slider coupled to the trayslide, wherein the input shaft is coupled to the trayslide adjustor and the output rod is coupled to the slider.

6. The food-line serving counter of claim 4, wherein at least one of the trayslide elevator assemblies comprises:
a linear actuator having an input shaft and an output rod; and
a slider coupled to the trayslide wherein the input shaft is coupled to the trayslide adjustor and the output rod is coupled to the slider, the slider comprising:
a slider guide coupled to the frame; and
a bracket guide slidably coupled and horizontally restrained to the slider guide, the bracket guide being coupled to the trayslide.

7. The food-line serving counter of claim 4, wherein the frame comprises at least two risers with a space formed between the risers, and wherein at least one of the trayslide elevator assemblies comprises:
a linear actuator having an input shaft and an output rod; and
a slider coupled to the trayslide wherein the input shaft is coupled to the trayslide adjustor, the slider comprising:
a slider guide coupled to the frame;
a bracket guide slidably coupled and horizontally restrained to the slider guide; and
a bracket coupled to the bracket guide and the trayslide, the output rod of the linear actuator being coupled to the bracket, the bracket being slidably disposed between the at least two risers in the space.

8. The food-line serving counter of claim 4, further comprising
a first trayslide elevator assembly comprising:
a linear actuator having a first input shaft and a first output rod; and
a slider coupled to the trayslide, wherein the first input shaft is coupled to the trayslide adjustor and the first output rod is coupled to the slider; and
a second trayslide elevator assembly comprising:
a linear actuator having at least a second input shaft and a second output rod; and
a slider coupled to the trayslide, wherein the second output rod is coupled to the slider;
wherein the first input shaft of the linear actuator of the first trayslide elevator assembly is coupled to the second input shaft of the linear actuator of the second trayslide elevator assembly so that each of the trayslide elevator assemblies move in uniformity with each other;

9. The food-line serving counter of claim 4, further comprising
a first trayslide elevator assembly comprising:
a linear actuator having a first input shaft and a first output rod; and
a slider coupled to the trayslide, wherein the first input shaft is coupled to the trayslide adjustor and the first output rod is coupled to the slider; and
a second trayslide elevator assembly comprising:
a linear actuator having at least a second input shaft and a second output rod; and
a slider coupled to the trayslide, wherein the second output rod is coupled to the slider;
a flexible coupling coupled to the first input shaft of the linear actuator of the first trayslide elevator assembly and to the second input shaft of the linear actuator of the second trayslide elevator assembly, the first input shaft of the linear actuator of the first trayslide elevator assembly being disposed at an angle to the second input shaft of the linear actuator of the second trayslide elevator assembly.
